(19) United States
(12) Patent Application Publication
(10) Pub. No.: US 2026/0074248 A1
(43) Pub. Date: Mar. 12, 2026

(54) FUEL CELL SYSTEM CONTROL USING CELL VOLTAGE MONITORING

(71) Applicant: FORD GLOBAL TECHNOLOGIES, LLC, Dearborn, MI (US)

(72) Inventors: Hao Wang, Ann Arbor, MI (US); Michiel J. Van Nieuwstadt, Ann Arbor, MI (US); Matthew Riley, Ann Arbor, MI (US); Valentina Mejia Mejia, Royal Oak, MI (US); Majed Ben-kalefa, Canton, MI (US); William Frederick Sanderson, JR., Commerce Twp, MI (US); Zeng Qiu, Ann Arbor, MI (US)

(21) Appl. No.: 18/883,387

(22) Filed: Sep. 12, 2024

(51) Int. Cl. H01M 8/04858; B60L 50/75; B60L 58/33; H01M 8/04119; H01M 8/0432; H01M 8/04537; H01M 8/04701; H01M 8/04746; H01M 8/04791

(52) U.S. Cl. CPC H01M 8/0491; H01M 8/04179; H01M 8/04358; H01M 8/04544; H01M 8/04723; H01M 8/04768; H01M 8/04798; B60L 50/75; B60L 58/33; H01M 2250/20

(57) ABSTRACT

This disclosure relates to a fuel cell system for vehicles that includes a controller that manages, among other things, the stack current and purge valve or drain valve operations based on a cell voltage monitoring energy indicator. When the energy indicator exceeds a predefined threshold, the controller reduces the stack current or adjusts the purge valve or drain valve—either opening it to mitigate flooding or closing it to prevent drying out.

### STATEMENT REGARDING FEDERALLY FUNDED RESEARCH

This invention was made with government support under Grant No. DE-EE0009858 awarded by the U.S. Department of Energy. The government has certain rights in the invention.

### TECHNICAL FIELD

This disclosure relates to fuel cell operation.

### BACKGROUND

Fuel cells are electrochemical devices that convert the chemical energy in hydrogen into electrical energy through a reaction with oxygen, producing water and heat as byproducts. In a typical fuel cell, hydrogen gas is introduced at the anode, where a catalyst splits it into protons and electrons. The protons move through an electrolyte membrane to the cathode, while the electrons travel through an external circuit, generating electricity. At the cathode, the protons, electrons, and oxygen from the air combine to form water. Fuel cells are often stacked together to provide the power required for various applications, including vehicles. In fuel cell vehicles, this stack supplies electricity to power the electric motor.

### SUMMARY

A vehicle is equipped with a fuel cell system and a controller designed to reduce the stack current of the fuel cell system when a cell voltage monitoring (CVM) energy indicator, which is derived from filtered voltage data, exceeds a predefined energy indicator threshold.

A method is implemented in which a purge valve or drain valve of the fuel cell system is opened after the CVM energy indicator surpasses the energy indicator threshold.

A controller closes a purge valve or drain valve of the fuel cell system once the CVM energy indicator exceeds the energy indicator threshold.

### BRIEF DESCRIPTION OF THE DRAWINGS

FIG. 1 is a block diagram of a vehicle.

FIG. 2 is a schematic diagram of a fuel cell system.

FIG. 3 is a block diagram of filtering logic for generating a CVM energy indicator.

FIGS. 4 and 5 are plots of various signals collected from physical system testing including CVM energy indicators.

### DETAILED DESCRIPTION

Embodiments are described herein, but it should be understood that these are merely examples and that other embodiments may take different forms. The figures presented are not necessarily to scale; some features may be exaggerated or minimized to highlight specific details of particular components. As a result, the structural and functional details disclosed are intended to be illustrative and not restrictive, serving as a representative basis for those skilled in the art to understand the concepts.

Features illustrated and described in reference to any one of the figures may be combined with features from one or more other figures to create embodiments not explicitly illustrated or described. The illustrated combinations of features represent typical applications, but various other combinations and modifications consistent with the teachings of this disclosure may be desirable for specific applications or implementations.

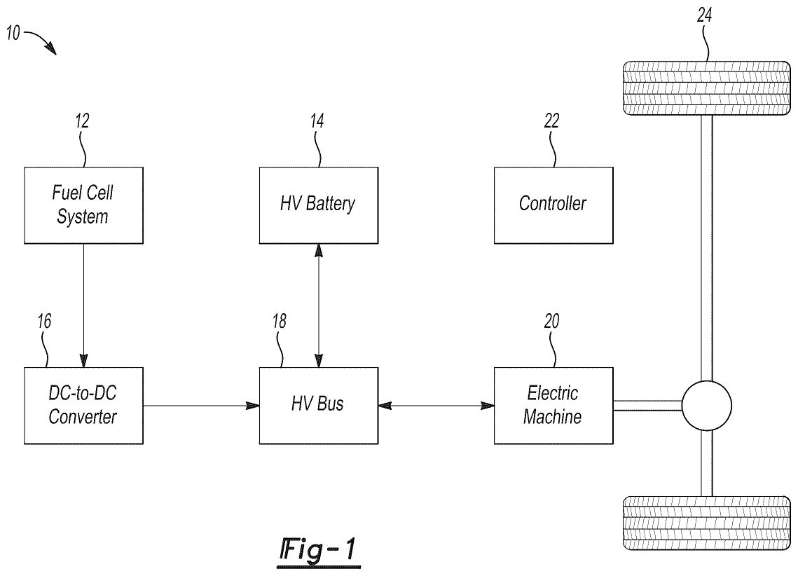

Referring to FIG. 1, a fuel cell electric vehicle (FCEV) 10 can be equipped with two onboard power sources: a fuel cell system 12 and a high-voltage (HV) battery 14. The fuel cell system 12 includes a fuel cell stack, which typically has hundreds of fuel cells electrically connected in series. These cells are contained within an enclosure that integrates reactants and coolant through manifolds into the stack. The fuel cell system 12 is connected to a DC-to-DC converter 16, which manages the voltage levels between the fuel cell system 12 and a HV Bus 18, facilitating power transfer to electric machine 20.

To achieve the desired power output from the fuel cell system 12, a controller 22 stabilizes voltages at both the stack and individual cell levels across all operating conditions. However, various modes—such as drying out, flooding, and icing within the fuel cell stack—can destabilize these voltages, disrupt power production, and reduce the durability of the stack. Direct measurement of all internal states of the fuel cell stack in production vehicles is not feasible. Instead, CVM of single or multiple cells provides a method for detecting such modes within the stack.

In the fuel cell anode systems connected to the fuel cell system 12, there are two methods of hydrogen (H₂) delivery: continuous flow and pulse injection. A continuous flow of H₂ can be supplied using a pump or a variable position valve. In contrast, pulse injection delivery uses an injection valve to control the anode pressure. When the anode pressure drops, the injection valve opens, allowing a rapid influx of H₂ into the anode loop. When the anode pressure is high, the valve closes, halting H₂ flow. This process causes fluctuations in H₂ flow and partial pressure, leading to oscillations in the voltage output of the fuel cell stack at a frequency similar to that of the H₂ injections. The HV battery 14, connected to both the HV Bus 18 and the electric machine 20, works in tandem with the fuel cell system 12 to deliver power to the electric machine 20, which ultimately drives wheels 24.

The proposed techniques leverage the voltage fluctuations in fuel cell systems with pulse-injected H₂ for mode detection. Under ideal operating conditions, the amplitude of these voltage fluctuations is minimal. However, it has been consistently observed during fuel cell system freeze startup that when icing conditions degrade a cell's performance, the corresponding cell voltage, as monitored by CVM, shows excessive oscillations that are closely synchronized with the H₂ injection frequency. Shortly after such instability is observed in a cell's voltage, it is much more likely that the voltage will dip significantly below zero, resulting in a cell reversal event that causes irreversible changes to the electrode catalysts within the fuel cell.

A real-time algorithm capable of extracting frequency domain characteristics from CVM measurements to detect unstable voltages within a fuel cell stack is proposed. The CVM system is integral to the operation of the fuel cell, as it continuously monitors the voltage across individual cells within the stack. By analyzing these voltage measurements in the frequency domain, the algorithm can identify characteristic patterns that signal specific modes such as membrane electrode assembly flooding, drying out, or icing. These voltage instabilities are correlated with other operational parameters, including temperature, humidity, and current draw, allowing the algorithm to accurately isolate and diagnose the modes. Upon identification of a mode, the system can then propose and implement specific mitigation actions to extend the fuel cell system's operational capabilities.

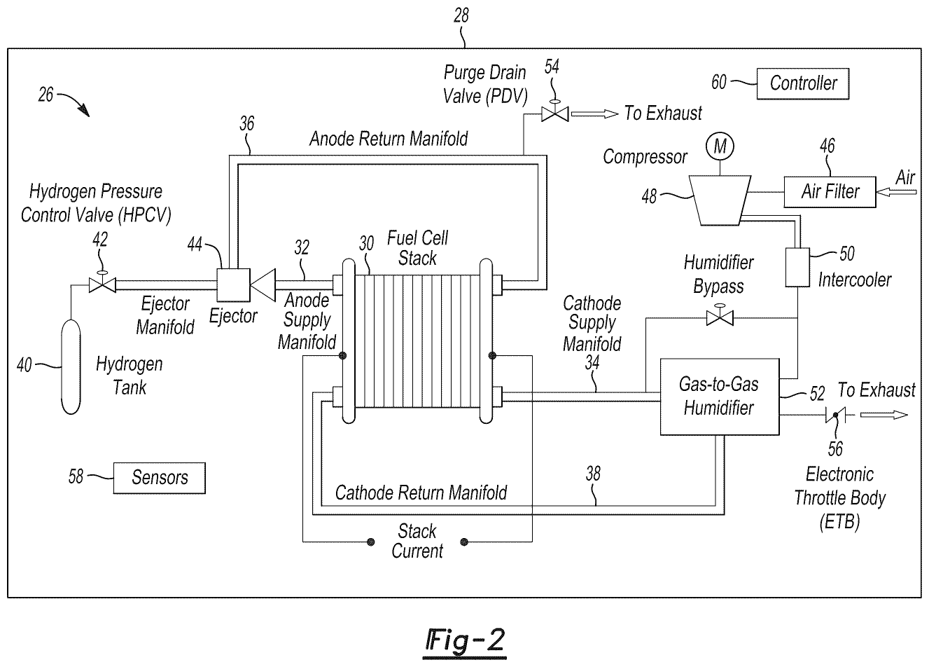

The fuel cell system 26 of vehicle 28, as depicted in FIG. 2, is an assembly of interconnected components, each playing a role in the system's functionality and control. At its core is fuel cell stack 30, where the electrochemical reactions take place, converting hydrogen and oxygen into electricity, water, and heat. The fuel cell stack 30 is fed by both the anode and cathode sides, each with its dedicated supply and return manifolds. Anode supply manifold 32 delivers hydrogen to the anode side of the fuel cell stack 30, while cathode supply manifold 34 provides oxygen to the cathode side. Anode return manifold 36 and cathode return manifold 38 manage the exhaust gases, ensuring that unreacted gases and byproducts are removed from the stack 30.

Hydrogen, stored in high-pressure tank 40, is managed by hydrogen pressure control valve 42, which maintains the appropriate pressure before the hydrogen enters ejector manifold 44. The ejector 44, a crucial component in the hydrogen delivery system, helps maintain the desired hydrogen flow rate, particularly under varying load conditions, which provides a consistent supply to the fuel cell stack 30 via the anode supply manifold 32. The control of hydrogen flow assists in maintaining stack performance and preventing conditions such as starvation or excessive pressure buildup.

On the cathode side, air required for the oxygen supply is drawn into the system 26 through air filter 46, which removes particulates and contaminants. The air is then pressurized by a compressor 48 to the required operating pressure before being cooled by intercooler 50. The cooled air passes through gas-to-gas humidifier 52, where it is humidified to maintain the necessary moisture levels in the fuel cell stack 30. This humidified air is then supplied to the cathode side of the stack 30 via the cathode supply manifold 34. The compressor speed, which determines the rate of air delivery, is a control actuator, and is adjusted based on the real-time oxygen demand of the stack 30, which fluctuates with the power output.

Humidity control is of interest, as the gas-to-gas humidifier 52 ensures that the air entering the cathode side is adequately humidified, preventing the electrolyte membrane within the fuel cell stack 30 from drying out. Maintaining proper humidity levels preserves membrane conductivity. The system 26 also includes a purge drain valve 54 (or separate purge and drain valves), which plays a role in managing water content within the anode side of the stack. The purge drain valve 54 removes excess water and unreacted hydrogen from the anode, preventing membrane electrode assembly flooding, a condition where excess water accumulation impedes the reaction process.

Electronic throttle body 56 is another component, controlling the airflow into the system 26 by adjusting the air intake based on real-time operational requirements. The electronic throttle body 56 works in conjunction with the compressor 48 and humidifier 52 to control the oxygen supply to the cathode at the appropriate humidity and temperature levels. Suitable sensors 58, such as temperatures sensors, current sensors, voltage sensors, humidity sensors, pressure sensors, mass air flow sensors, etc., are arranged as known in the art to collect the various data needed. Controller 60, a central processing unit within the system 26, manages all these operations. It may use automotive communication protocols such as CAN (Controller Area Network), LIN (Local Interconnect Network), and/or FlexRay to establish communication channels. The controller 60 coordinates the actions of the components of FIG. 2 by using real-time data from the various sensors, including CVM, temperature, humidity, and pressure sensors, to manage the fuel cell stack's operation and implement mitigation actions as needed.

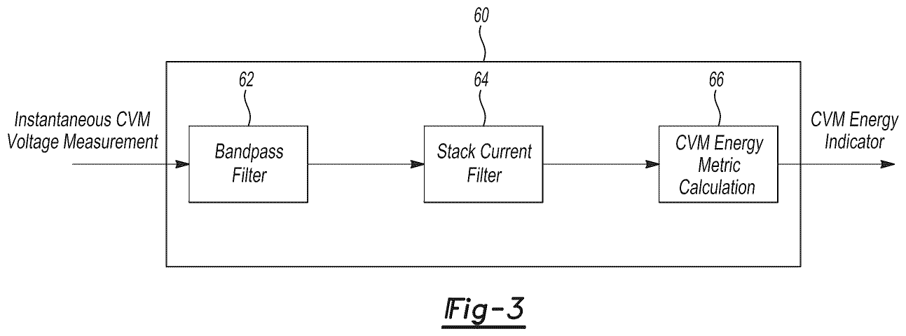

FIG. 3 illustrates the design workflow of the CVM filtering logic, a process that begins with the instantaneous CVM voltage measurements. These measurements can originate from any time-domain CVM channel, reporting either single-cell or multiple-cell voltage readings within the fuel cell stack 30. The workflow filters and analyzes these measurements to detect specific patterns indicative of certain modes, particularly those related to anode operation, including H₂ injection/ejection and purge drain valve open/close as discussed in the context of FIG. 2.

The process starts with the raw time-domain CVM voltage measurement, which is input into a bandpass filter 62. The bandpass filter 62 isolates and extracts the frequency-domain characteristics of the signal. Specifically, it filters out any frequencies outside a small range centered around the H₂ injection frequency, which is helpful in identifying oscillations related to hydrogen delivery. The bandpass filter 62 can be implemented in real-time, potentially using a Butterworth digital filter design, known for its flat frequency response in the passband and sharp cutoff characteristics. The purpose of this filter is to focus the analysis on the relevant frequency range, removing noise and other irrelevant frequency components that could obscure the detection of certain modes like flooding or icing within the fuel cell stack 30.

Once the signal has been refined by the bandpass filter 62, it proceeds to a stack current filter 64. This filter specifically targets the rate of change in the stack current, a parameter in fuel cell operation. The stack current filter 64 functions by eliminating data points corresponding to large load transients, which are periods when the stack 30 experiences significant and rapid changes in power demand. These transients can cause substantial deviations in the CVM measurements, potentially leading to false positives or masking the true indicators of certain modes. By filtering out these transient effects, the stack current filter 64 allows the subsequent analysis to focus only on voltage variations that are related to the health and performance of the fuel cell stack 30 under steady-state or minor load variations.

The final step in the workflow is the CVM energy metric calculation 66. This calculation generates the CVM energy indicator, a metric used to assess the overall condition of the fuel cell stack 30. The CVM energy metric is derived by integrating the absolute values of a series of consecutive outputs from the stack current filter 64. This integration occurs over a moving time window, which slides across the filtered data in real-time. By summing the absolute values, the metric captures the total energy associated with voltage fluctuations within the relevant frequency band, providing an indicator of potential issues within the stack 30. For instance, an increase in the CVM energy indicator could signal the onset of a certain mode, such as membrane drying or flooding, prompting further investigation or immediate corrective actions.

Through the integration of these filtering stages—bandpass filtering, stack current filtering, and energy metric calculation—the CVM filtering logic isolates and highlights voltage fluctuations that may be indicative of underlying issues in the fuel cell system 26.

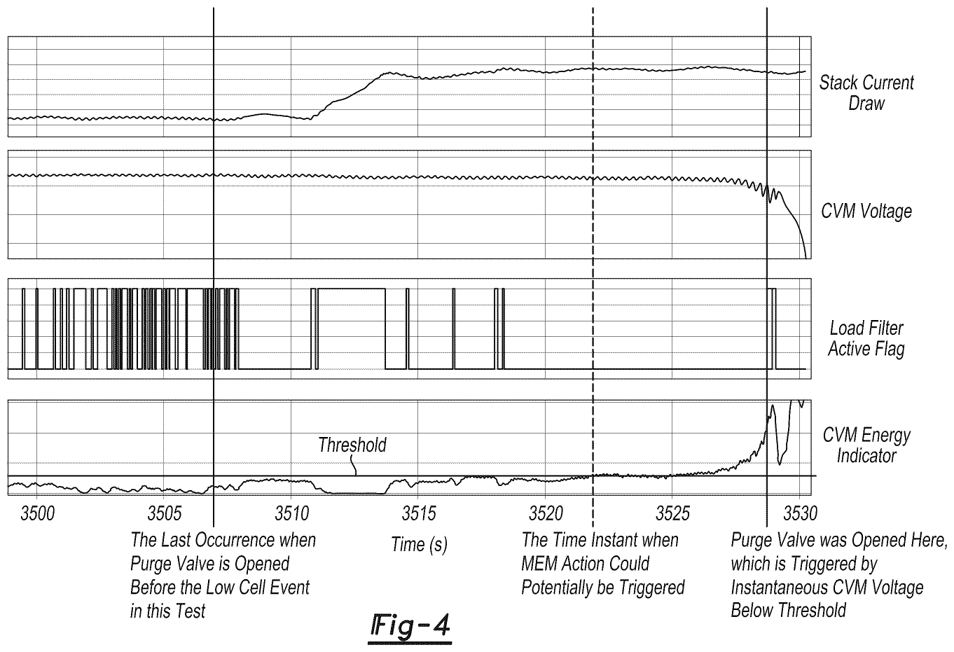

FIG. 4 illustrates the application of the proposed CVM filter to detect a flooding event within a fuel cell system. During this specific test, the fuel cell system experienced a low cell voltage event at approximately 3529 seconds, leading to an automatic shutdown to protect the system. This low voltage event was triggered by a membrane electrode assembly flooding mode, which was caused by insufficient anode purge control. The annotated data shows that the last anode purge event occurred around 3507 seconds, after which the system continued to operate without an anode purge for roughly 22 seconds.

As shown in the figure, existing mode effects mitigation (MEM) was activated at around 3528 seconds when the instantaneous CVM voltage dropped below the normal operating threshold. However, by this time, it was too late to prevent the shutdown triggered by the flooding mode. The delay in initiating the purge allowed the flooding condition to worsen, leading to the voltage drop that necessitated the system shutdown.

When the proposed CVM filter was applied to the corresponding voltage measurements, the stack's operational issue could be detected much earlier, around 3522 seconds. At this point, the CVM energy indicator, as shown in the bottom graph of the figure, increased above the prescribed threshold, signaling the onset of a potential condition of interest. If the mode effect mitigation action had been initiated at 3522 seconds instead of 3528 seconds, this 6-second headroom could have been sufficient to purge the excess water from the stack, thereby preventing the subsequent flooding mode and shutdown.

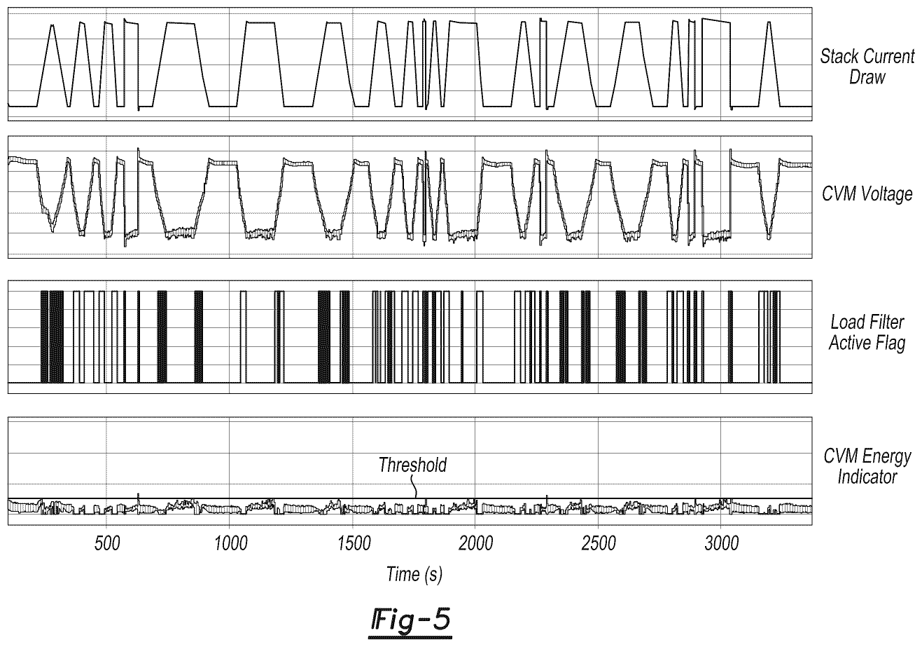

The next step in the analysis involved applying the same CVM filter to data from a normal fuel cell system operation where no significant mode is present. In this scenario, the FCS undergoes highly dynamic operation characterized by drastic changes in stack load, as evident from the top plot in FIG. 5. Despite these large and frequent load fluctuations, the CVM filter isolates and processes the voltage data.

The bottom plot in FIG. 5 shows the CVM energy indicator, which remains below the threshold for detecting stack issues throughout the test. This indicates that the filter successfully distinguishes between normal load-induced voltage variations and those that would signify potential stack issues. The same threshold used for detecting issues in FIG. 4 is applied here, yet the system correctly identifies that the observed voltage changes are attributable to normal operational dynamics rather than any underlying problematic modes.

The CVM filter design can be extended to identify other modes, including an icing condition during freeze startup and a membrane electrode assembly dry out condition that probably occurs during high-load operation in hot ambient temperatures. Table 1 shows the proposed isolation criteria for different modes and corresponding mode effects mitigation actions that can be applied.

TABLE 1

| Mode | Isolation Criteria | FMEM Actions |
|---|---|---|
| Icing | CVM Energy of any | Reduce the stack current; |
| during | channel > threshold; Coolant | Command coolant |
| freeze | inlet temperature < | temperature to higher |
| startup | threshold; Stack current > | setpoint; Adjust |
| | threshold. | cathode/anode pressure to |
| | | higher setpoints; Implement |
| | | purging; Drop into low |
| | | stoichiometric mode to |
| | | increase heat generation; |
| | | and/or Adjust coolant flow |
| | | rate. |
| Flooding | CVM Energy of any | Command purge valve open; |
| | channel > threshold; higher | Increase cathode mass air |
| | threshold > Coolant inlet | flow; |
| | temp > lower threshold; | Increase stack pressure; |
| | Stack current > threshold; | Bypass humidifier; |
| | Cathode inlet humidity > | Command coolant inlet |
| | threshold. | temperature to higher |
| | | setpoint within limits of |
| | | thermal control; and/or |
| | | Adjust coolant flow rate. |
| Dry out | CVM Energy of any | Command purge valve close; |
| | channel > threshold; Coolant | Reduce cathode mass air |
| | inlet temp > threshold; | flow; |
| | Stack current > threshold; | Increase stack pressure; |
| | Cathode inlet humidity < | Command coolant inlet temp |
| | threshold. | to lower setpoint; |
| | | Reduce coolant delta |
| | | temperature (outlet − inlet) |
| | | setpoint; |
| | | Reduce stack current if CVM |
| | | energy indicator not reduced |
| | | below normal threshold after |
| | | timeout period. |

The thresholds referenced in Table 1 for various modes, such as CVM energy levels, coolant inlet temperature, stack current, and cathode inlet humidity, are parameters that dictate when certain mode effects mitigation should be triggered. These thresholds can be established through experimental testing, simulation, or data analysis.

In a testing environment, a fuel cell system can be subjected to controlled conditions that simulate potential scenarios, such as icing during freeze startup, flooding, or dry-out. By closely monitoring the system's behavior under these conditions, the specific CVM energy levels, temperatures, and other parameters that indicate the onset of a mode can be identified. For instance, during a simulated freeze startup, the coolant inlet temperature may be gradually lowered while monitoring the CVM energy indicator. The point at which the CVM energy surpasses a certain value, coupled with a drop in coolant temperature below a predefined level, may signal the threshold at which icing becomes a possibility. This threshold can then be used in the operational system to trigger proactive actions before icing becomes problematic.

Similarly, in the case of flooding, testing can be conducted where an anode purge valve is intentionally delayed or withheld, and the corresponding effect on stack current and cathode inlet humidity observed. The CVM energy indicator, along with stack current and humidity levels, can be recorded to determine at what point the system begins to experience flooding. These tests help define thresholds that, when reached, will prompt actions such as increasing the cathode mass air flow or bypassing the humidifier to prevent the flood from progressing.

In addition to physical testing, simulation tools can play a role in threshold determination. Simulation models can replicate fuel cells system operation under a variety of environmental conditions and stress factors, allowing for the prediction of system responses without the need for physical tests. For example, a simulation might model the effect of prolonged high-current operation on the likelihood of dry-out, helping to establish the maximum current threshold before the stack begins to lose humidity. These simulations can also account for variations in component performance, environmental factors, and system aging, providing a view of how thresholds should be set.

To assist with detecting use of the strategies contemplated herein in the field, a vehicle can be outfitted with a combination of sensors and diagnostic tools. A data logging system that interfaces with the vehicle's onboard diagnostics would give access to parameters values such as fuel cell stack voltage, current draw, coolant temperature, and air mass flow rates. Additional sensors such as thermocouples and humidity sensors can be placed on the coolant inlet and outlet pipes to monitor the temperature delta, as well as at the cathode air intake to measure humidity levels. These sensors may help in detecting whether the vehicle is actively controlling the coolant temperature, adjusting air stoichiometry, or altering the coolant flow rate to manage specific fuel cell conditions like icing, flooding, or dry-out.

The vehicle could then be subjected to a series of controlled operational conditions to gather data. For example, the vehicle may be operated in a cold environment to observe whether the coolant inlet temperature is actively being managed to a higher setpoint during a freeze startup, indicative of a strategy to prevent icing. Additionally, varying load conditions may be simulated, such as rapid acceleration or climbing steep inclines, to observe the vehicle's stack current response and any corresponding adjustments in coolant temperature or air mass flow rates.

During these tests, the data logger could be configured to capture high-resolution time-series data, including stack current, CVM energy indicators, and sensor outputs for temperature and humidity. After processing this data to yield the CVM energy indicator as described with reference to FIG. 3, specific patterns, such as a rapid increase in CVM energy followed by a prompt adjustment in coolant temperature or the activation of purge valves, would suggest that the vehicle is employing actions in response to detected fuel cell stack issues.

The timing and sequence of these responses could be monitored. For example, a delayed but significant increase in coolant temperature shortly after the CVM energy indicator rises might indicate the system's attempt to mitigate an emerging mode like icing or flooding. Conversely, a gradual reduction in stack current in response to persistent high CVM energy levels could suggest that the vehicle's control system is attempting to prevent a dry-out condition by managing load or reducing the air stoichiometry.

The algorithms, methods, or processes disclosed herein can be delivered to or implemented by a computer, controller, or processing device, which may include any dedicated or programmable electronic control unit. These algorithms, methods, or processes can be stored as data and executable instructions in various forms, including non-writable storage media such as read-only memory (ROM) and writable storage media such as compact discs, random access memory (RAM), or other magnetic and optical media. Additionally, they can be implemented as software executable objects or embodied, either partially or fully, in hardware components such as application-specific integrated circuits (ASICs), field-programmable gate arrays (FPGAs), state machines, or a combination of firmware, hardware, and software.

Although exemplary embodiments are described above, they are not intended to encompass all possible forms within the scope of the claims. The terminology used in the specification is intended to describe, not limit, the scope, and it is understood that various modifications can be made without departing from the spirit and scope of the disclosed materials. For instance, “controller” and “controllers” may be used interchangeably, as the functionality of one controller can be distributed across multiple controllers, which may communicate using standard techniques. “Purge valve” or “drain valve” can mean “purge drain valve” as these valves may be integrated in certain implementations.

As previously mentioned, features from different embodiments may be combined to create further embodiments that may not be explicitly described or illustrated. While some embodiments might be described as offering advantages or being preferred over others with respect to certain desired characteristics, those skilled in the art understand that trade-offs might be necessary to achieve overall system attributes that depend on specific applications and implementations. These attributes could include, but are not limited to, strength, durability, marketability, appearance, packaging, size, serviceability, weight, manufacturability, and ease of assembly. Therefore, embodiments that are described as less desirable in certain respects are not outside the scope of this disclosure and may, in fact, be preferable for particular applications.

What is claimed is:

1. A vehicle comprising:
a fuel cell system; and
a controller programmed to reduce a stack current of the fuel cell system after a cell voltage monitoring energy indicator, derived from filtered voltage data of the fuel cell system, exceeds an energy indicator threshold.

2. The vehicle of claim 1, wherein the controller is further programmed to reduce the stack current responsive to the cell voltage monitoring energy indicator exceeding the energy indicator threshold while a coolant inlet temperature of the fuel cell system is less than a temperature threshold and the stack current is greater than a current threshold.

3. The vehicle of claim 1, wherein the controller is further programmed to increase a coolant temperature of the fuel cell system after the cell voltage monitoring energy indicator exceeds the energy indicator threshold.

4. The vehicle of claim 1, wherein the controller is further programmed to adjust stack pressure setpoints of the fuel cell system after the cell voltage monitoring energy indicator exceeds the energy indicator threshold.

5. The vehicle of claim 1, wherein the controller is further programmed to purge the fuel cell system after the cell voltage monitoring energy indicator exceeds the energy indicator threshold.

6. The vehicle of claim 1, wherein the controller is further programmed to alter a stoichiometric operating mode of the fuel cell system after the cell voltage monitoring energy indicator exceeds the energy indicator threshold.

7. The vehicle of claim 1, wherein the controller is further programmed to adjust a coolant flow rate of the fuel cell system after the cell voltage monitoring energy indicator exceeds the energy indicator threshold.

8. A method comprising:
opening a purge valve or drain valve of a fuel cell system after a cell voltage monitoring energy indicator, derived from filtered voltage data of the fuel cell system, exceeds an energy indicator threshold.

9. The method of claim 8 further comprising opening the purge valve or drain valve responsive to the cell voltage monitoring energy indicator exceeding the energy indicator threshold while a coolant inlet temperature of the fuel cell system is greater than a temperature threshold, a stack current of the fuel cell system is greater than a current threshold, and a cathode inlet humidity of the fuel cell system is greater than a humidity threshold.

10. The method of claim 8 further comprising increasing cathode mass air flow of the fuel cell system after the cell voltage monitoring energy indicator exceeds the energy indicator threshold.

11. The method of claim 8 further comprising increasing a pressure of the fuel cell system after the cell voltage monitoring energy indicator exceeds the energy indicator threshold.

12. The method of claim 8 further comprising increasing a coolant inlet temperature of the fuel cell system after the cell voltage monitoring energy indicator exceeds the energy indicator threshold.

13. The method of claim 8 further comprising adjusting a coolant flow rate of the fuel cell system after the cell voltage monitoring energy indicator exceeds the energy indicator threshold.

14. An automotive power system comprising:
a controller programmed to close a purge valve or drain valve of a fuel cell system after a cell voltage monitoring energy indicator, derived from filtered voltage data of the fuel cell system, exceeds an energy indicator threshold.

15. The automotive power system of claim 14, wherein the controller is further programmed to close the purge valve or drain valve responsive to the cell voltage monitoring energy indicator exceeding the energy indicator threshold while a coolant inlet temperature of the fuel cell system is greater than a temperature threshold, a stack current of the fuel cell system is greater than a current threshold, and a cathode inlet humidity of the fuel cell system is less than a humidity threshold.

16. The automotive power system of claim 14, wherein the controller is further programmed to reduce cathode mass air flow of the fuel cell system after the cell voltage monitoring energy indicator exceeds the energy indicator threshold.

17. The automotive power system of claim 14, wherein the controller is further programmed to increase a stack pressure of the fuel cell system after the cell voltage monitoring energy indicator exceeds the energy indicator threshold.

18. The automotive power system of claim 14, wherein the controller is further programmed to decrease a coolant inlet temperature of the fuel cell system after the cell voltage monitoring energy indicator exceeds the energy indicator threshold.

19. The automotive power system of claim 14, wherein the controller is further programmed to alter a stoichiometric operating mode of the fuel cell system after the cell voltage monitoring energy indicator exceeds the energy indicator threshold.
